(19) United States
(12) Patent Application Publication
(10) Pub. No.: US 2026/0226878 A1
(43) Pub. Date: Aug. 6, 2026

(54) DETECTING KNOCK USING AN ARIMA MODEL

(71) Applicant: Robert Bosch GmbH, Stuttgart (DE)

(72) Inventors: Tushar Parulekar, Portage, MI (US); Sandeep Chilukuri, Farmington Hills, MI (US)

(21) Appl. No.: 19/044,052

(22) Filed: Feb. 3, 2025

(51) Int. Cl. F02P 5/152; F02D 35/02

(52) U.S. Cl. CPC F02P 5/152; F02D 35/027

(57) ABSTRACT

A system for detecting knock using an Autoregressive Integrated Moving Average (ARIMA) model. The system includes an electronic processor. The electronic processor is configured to receive a signal from a knock sensor and using the ARIMA model, determine constituents of the signal, wherein the constituents include a residual constituent. The electronic processor is also configured to determine, based on an amplitude of the residual constituent, whether a combustion is a knocking combustion or a non-knocking combustion.

### SUMMARY

Internal combustion engines often include one or more cylinders and each cylinder is associated with a piston and a spark plug. In a spark ignited engine, combustion of ingested air-fuel mixture starts after a spark from the spark plug creates a flame front which propagates through the length of a cylinder away from the cylinder head (where the spark plug is generally mounted). However, in some combustions, when there is some hot spot in the cylinder, there is a possibility that another flame front (one that is not caused by the spark plug igniting) will propagate in the opposite direction. A combustion is classified as a knocking combustion, when the two flame fronts collide, generating shock waves and creating an undesirable temperature/pressure rise in the engine cylinder. The collision of the two flame fronts is sometimes referred to as engine knock. The combustion cycle corresponds to one complete revolution of a crank shaft included in an engine. Knocking may cause damage to the engine, passenger discomfort, and/or affect engine performance. Therefore, it is desirable to detect when knock is occurring and adjust the timing of ignition of the spark plug accordingly in future combustion cycles.

Knock detection systems and methods utilize data collected by knock sensors to determine whether knock occurred. A knock sensor may be a piezoelectric sensor that is mounted on the outside of an engine block. The knock sensor may create an electric signal of varying voltage based on the intensity of the vibrations on the engine block (for example, vibrations produced by knocking combustions). When there is a highly noisy combustion, there are higher vibrations on the engine block. High vibrations on the engine block in turn cause the knock sensor to produce a momentarily high voltage signal associated with the highly noisy combustion. Highly noisy combustions may be referred to as knocking combustions. Currently, the signal from knock sensors may be analyzed using fast Fourier transforms (FFT), frequency filtering, wavelet transforms, machine learning models, or a combination of the foregoing. However, these current systems and methods for detecting knock are computationally expensive, prone to error, and may require a human operator. Additionally, in current systems and methods, data from a sensor other than a knock sensor (for example, a pressure sensor) may be required to establish or calibrate a predetermined threshold to utilize when determining whether knock occurred. In contrast, when establishing a predetermined threshold utilized by the systems and methods described herein to perform knock detection, only a knock sensor needs to be utilized.

For example, FIG. 1 is a flowchart illustrating a currently implemented method 100 for detecting knock using data or a signal from a knock sensor. In FIG. 1, block 105 represents data or a signal received from a knock sensor during a predefined window of time (a measurement window). At block 110, the signal is Fast Fourier transformed. At block 115, a linear model is used to filter the noise from the signal. At block 120, the sum of the weighted FFT spectra of the signal is calculated. At block 125, result adaptation is performed to increase the signal to noise ratio between knocking and non-knocking combustions. At block 130, the ratio is compared to a reference level to determine whether knocking occurred and to classify the intensity of the knock. The method 100 requires manual work or effort by a human to calibrate the functions utilized in the method 100. The method 100 also requires a large amount of computational processing power, training, a user with calibration expertise, and instrumentation of the engine.

Implementations described herein provide, among other things, a less computationally intense and more reliable way of determining if knock occurred using data from a knock sensor signal. In some instances, the implementations described herein utilize an Autoregressive Integrated Moving Average (ARIMA) model to analyze the signal received from a knock sensor and determine if knocking occurred (in other words, to classify combustions as either knocking or non-knocking).

For example, one implementation provides a system for detecting knock using an ARIMA model. The system includes an electronic processor. The electronic processor is configured to receive a signal from a knock sensor and using the ARIMA model, determine constituents of the signal, wherein the constituents include a residual constituent. The electronic processor is also configured to determine, based on an amplitude of the residual constituent, whether a combustion is a knocking combustion or a non-knocking combustion.

Another example implementation provides a method for detecting knock using an ARIMA model. The method including receiving a signal from a knock sensor and, using the ARIMA model, determining constituents of the signal, wherein the constituents include a residual constituent. The method further includes determining, based on an amplitude of the residual constituent, whether a combustion is a knocking combustion or a non-knocking combustion.

### BRIEF DESCRIPTION OF THE DRAWINGS

FIG. 1 is an example flowchart illustrating a method for detecting knock using a Fast Fourier Transform.

FIG. 2 is a block diagram of an example system for detecting knock using an Autoregressive Integrated Moving Average (ARIMA) model, in accordance with some implementations.

FIG. 3 is an example block diagram of the components included in the ECU of FIG. 2, in accordance with some implementations.

FIG. 4 illustrates an example method for detecting knock using an ARIMA model, in accordance with some implementations.

FIG. 5 is an example of a signal received when a high intensity knocking combustion occurred in a cylinder and the constituents of the signal, in accordance with some implementations.

FIG. 6 is an example of a noisy signal received when a knocking combustion did not occur in a cylinder and the constituents of the noisy signal, in accordance with some implementations.

FIG. 7 is an example of a signal received when a light intensity knocking combustion occurred in a cylinder and the constituents of the signal, in accordance with some implementations.

FIG. 8 provides an example flowchart of a method for detecting knock using an ARIMA model, in accordance with some implementations.

### DETAILED DESCRIPTION

Before any implementations, examples, aspects, and features are explained in detail, it is to be understood that they are not limited in their application to the details of construction and the arrangement of components set forth in the following description or illustrated in the following drawings. Other implementations, examples, aspects, and features are possible, and they are capable of being practiced or of being carried out in various ways.

For ease of description, some or all of the example systems presented herein are illustrated with a single exemplar of each of its component parts. Some examples may not describe or illustrate all components of the systems. Other examples may include more or fewer of each of the illustrated components, may combine some components, or may include additional or alternative components.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

It should also be understood that although certain drawings illustrate hardware and software located within particular devices, these depictions are for illustrative purposes only. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

Thus, in the claims, if an apparatus or system is claimed, for example, as including an electronic processor or other element configured in a certain manner, for example, to make multiple determinations, the claim or claim element should be interpreted as meaning one or more electronic processors (or other element) where any one of the one or more electronic processors (or other element) is configured as claimed, for example, to make some or all of the multiple determinations. To reiterate, those electronic processors and processing may be distributed.

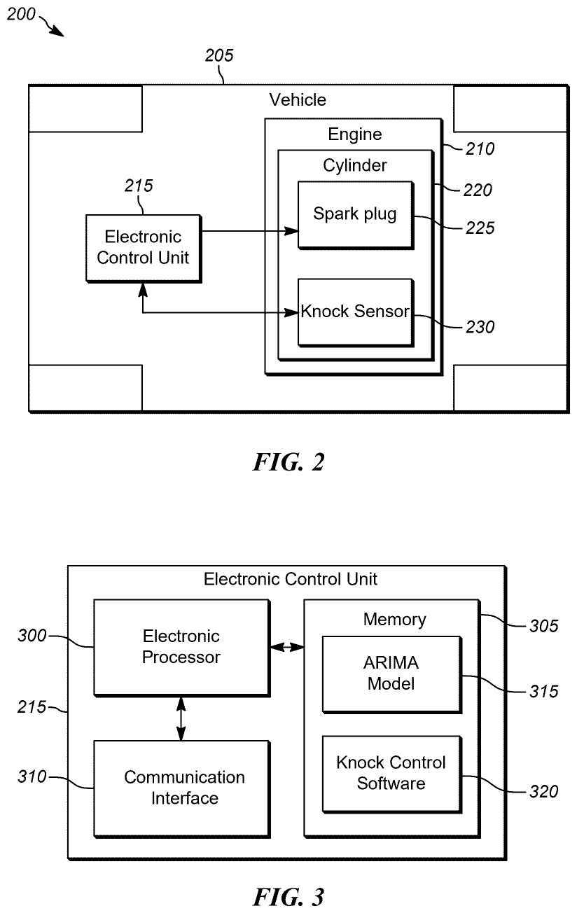

FIG. 2 illustrates an example system 200 for detecting knock using an Autoregressive Integrated Moving Average (ARIMA) model. In the implementation illustrated in FIG. 2, the system 200 is included in a vehicle 205. While illustrated in FIG. 2 as a four-wheel vehicle, the vehicle 205 may be any type of vehicle, for example, a two-wheel vehicle such as a motorcycle, a three-wheel vehicle such as a tricycle, or an eight-wheel vehicle such as a semi-truck. In the illustrated implementation, the system 200 includes an engine 210 and an electronic control unit (ECU) 215. The engine 210 includes a cylinder 220. A spark plug 225 attached to the cylinder 220 may be configured to ignite the air-fuel mixture in the cylinder 220. A knock sensor 230 may be mounted on the engine 210, on the engine housing (the engine block), or inside the cylinder 220. The knock sensor 230 may be configured to measure vibrations caused by the combustions occurring in the cylinder 220. In some implementations, the engine 210 includes a plurality of cylinders rather than the single cylinder 220 illustrated in FIG. 2 and each of the plurality of cylinders includes a spark plug. In some implementations, each cylinder included in the engine 210 is associated with a knock sensor. For example, each cylinder may include a knock sensor or each cylinder may be associated with a knock sensor mounted on the engine 110 or engine housing proximate to the cylinder.

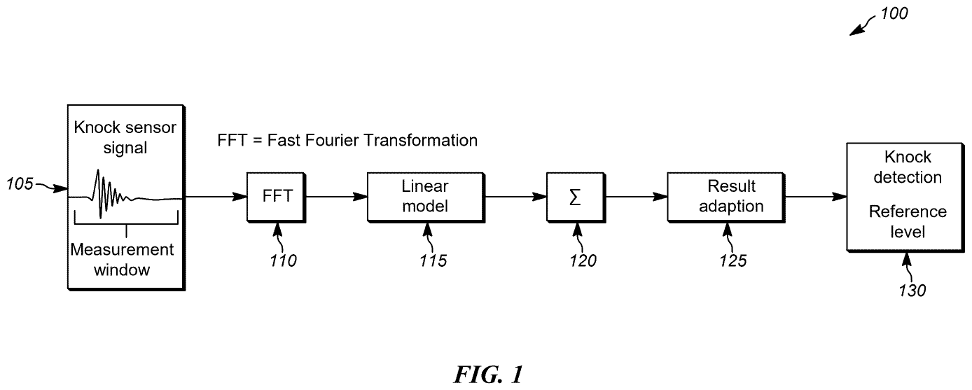

In some implementations, the ECU 215 is electrically and communicatively coupled to the spark plug 225 and the knock sensor 230 via direct or indirect connections or by or through one or more control or data buses, which enable communication therebetween. In some instances, the bus is a Controller Area Network (CAN™) bus. In some instances, the bus is an automotive Ethernet™, a FlexRay™ communications bus, or another suitable bus. In alternative instances, some or all of the components of the vehicle 205 may be communicatively coupled using suitable wireless modalities (for example, Bluetooth™ or near field communication connections). Connections illustrated in FIG. 1 as being unidirectional may be, in some implementations, bidirectional. Connections illustrated in FIG. 1 as being bidirectional may be, in some implementations, unidirectional.

FIG. 3 illustrates an example of the components included in the ECU 215. In the example shown, the ECU 215 includes an electronic processor 300 (for example, a microprocessor, application specific integrated circuit, etc.), a memory 305, and a communication interface 310. The memory 305 may be made up of one or more non-transitory computer-readable media. The memory 305 can include combinations of different types of memory, such as read-only memory (“ROM”), random access memory (“RAM”), electrically erasable programmable read-only memory (“EEPROM”), flash memory, or other suitable memory devices. The electronic processor 300 is coupled to the memory 305 and the communication interface 310. The electronic processor 300 sends and receives information (for example, from the memory 305 and/or the communication interface 310) and processes the information by executing one or more software instructions or modules, capable of being stored in the memory 305, or another non-transitory computer readable medium. The software can include firmware, one or more applications, program data, filters, rules, one or more program modules, and other executable instructions. The electronic processor 300 is configured to retrieve from the memory 305 and execute, among other things, software for performing methods as described herein. For example, the memory 305 includes an ARIMA model 315 and knock control software 320.

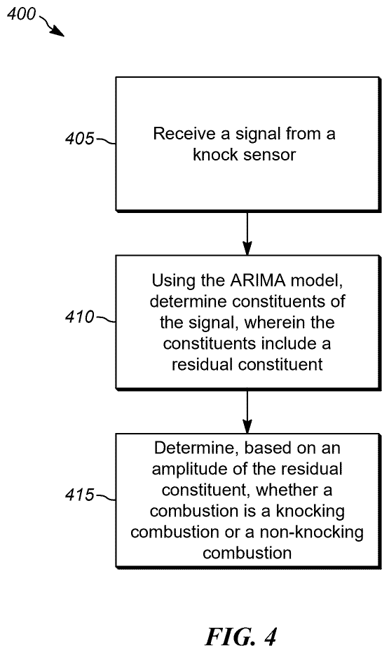

FIG. 4 illustrates an example method 400 for detecting knock using an ARIMA model. In some implementations, the method 400 begins at block 405 when the electronic processor 300 receives a signal from a knock sensor (for example, the knock sensor 230). In some implementations, the received signal represents data collected during a predetermined window of time. The predetermined window of time may include data captured during a combustion event in a cylinder (for example, the cylinder 220) included in the engine 210. The electronic processor 300 may, when the engine 210 includes a plurality of cylinders, determine the cylinder the combustion event captured by the signal occurred within based on a count maintained by the electronic processor 300. In some implementations, the electronic processor 300 may, when the engine 210 includes a plurality of cylinders, determine the cylinder the combustion event captured by the signal occurred within based on the knock sensor the signal is received from.

In some implementations, at block 410, the electronic processor 300, using an ARIMA model (for example, the ARIMA model 315), determines constituents of the signal. In some implementations, the constituents include a residual constituent, a seasonality constituent, and a trend constituent. The seasonality, trend, and residual constituents repeat themselves and therefore provide reference noise on the engine 210. Only when there is variation in the residual (sharp noise), did a knocking combustion occur. The trend and seasonality constituents separate out the repeatability in the knock sensor signal, allowing variation in the residual constituent to be pronounced and, therefore, aiding differentiation of a non-knocking or regular combustion (low residual value) from a knocking combustion (high residual value). In some implementations, the seasonality constituent represents the seasonality characteristic of the knock sensor signal. The seasonality characteristic represents regular and predictable changes that occur on the knock sensor signal at regular interval (for example, every combustion). In some implementations, the trend constituent represents the trend characteristic of the knock sensor signal. The trend characteristic represents gradual changes in the knock sensor signal such as increases or decreases in values occurring over long time period (for example, hundreds of combustions). In some implementations, the residual constituent represents the residual characteristic of the knock sensor signal. The residual characteristic of the signal represents noise or sudden non-repeating changes in the knock sensor signal. In some implementations, at block 415, the electronic processor 300, determines, based on an amplitude of the residual constituent, whether a combustion is a knocking combustion or a non-knocking combustion.

In some implementations, determining whether a combustion is a knocking combustion or a non-knocking combustion includes comparing the amplitude of the residual constituent to one or more thresholds to determine whether a combustion is a knocking combustion or a non-knocking combustion and, when a knocking combustion occurred, the strength of the knocking combustion. For example, the electronic processor 300 may compare the amplitude of the residual constituent to a first predetermined threshold to determine that a light intensity knocking combustion occurred (classify a knocking combustion as a light intensity knocking combustion). The electronic processor 300 may compare the amplitude of the residual constituent to a second predetermined threshold to determine that a medium intensity knocking combustion occurred (classify a knocking combustion as a medium intensity knocking combustion). The electronic processor 300 may compare the amplitude of the residual constituent to a third predetermined threshold to determine that a high intensity knocking combustion occurred (classify a knocking combustion as a high intensity knocking combustion). Whether a knocking combustion is high intensity, medium intensity, or low intensity may depend on the energy of an opposing flame front arising from hot spots in the cylinder 220 rather than from the spark plug 225. The earlier the opposing flame front initiates, the stronger the opposing flame front will be. The stronger the opposing flame front is, the stronger the collision of the opposing flame front with the primary flame front is. In some implementations, the stronger the collision, the greater the vibration on the engine block, the greater the signal produced by the knock sensor, the higher the residual value, and the greater the intensity of the knocking combustion. Thus, the earlier the opposing flame front ignites, the higher the intensity of the knock will be. The earlier the air-fuel mixture is ignited by a spark plug, the higher the chances that an opposing flame will initiate and initiate early. Thus, the earlier the ignition of the spark plug is, the more likely it is that a knocking combustion will occur and be a high intensity knocking combustion. In some implementations, the first predetermined threshold is lower than the second predetermined threshold and the third predetermined threshold. In some implementations, the third predetermined threshold is greater than the second predetermined threshold and the first predetermined threshold. In some implementations, the second predetermined threshold is greater than the first predetermined threshold and less than the third predetermined threshold.

In some implementations, thresholds (for example, the first predetermined threshold, the second predetermined threshold, and the third predetermined threshold) may be determined during a software calibration process prior to software that, when executed, causes the functionality described herein to be performed being installed in the memory of vehicles in mass. In some implementations, the electronic processor 300 may execute a script to extract a signal from a knock sensor and/or its constituents so that the signal and constituents may be displayed to a user (a technician) performing the calibration process when the signal is received in a Kistler Kibox in .open file format.

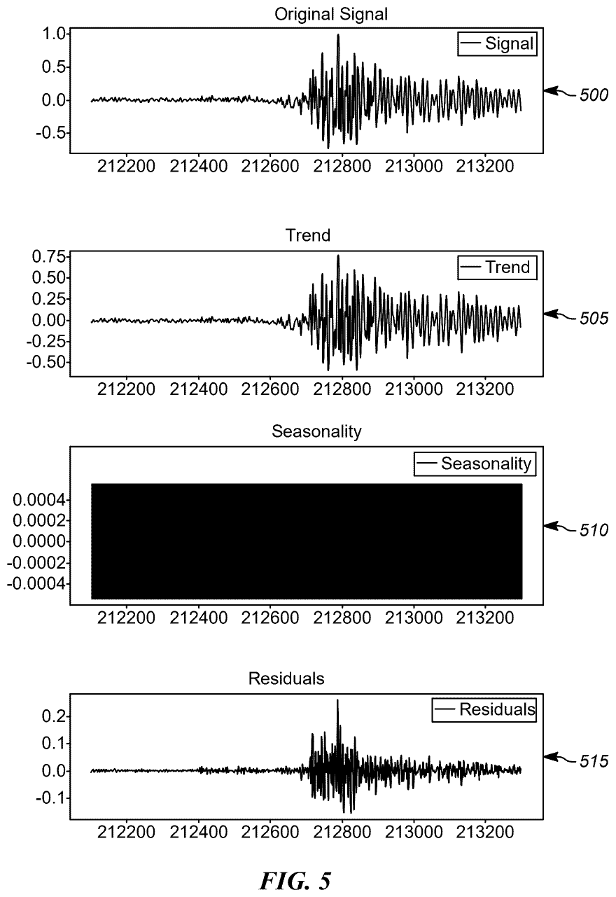

FIG. 5 includes an example of a signal received when a high intensity knocking combustion occurred in a cylinder and the constituents of the signal. Graph 500 represents the original signal received from a single knock sensor (for example, the knock sensor 230). Graph 505 represents the trend constituent of the signal illustrated in the graph 500. Graph 510 represents the seasonality constituent of the signal illustrated in the graph 500. Graph 515 represents the residual constituent of the signal illustrated in the graph 500. In each of the graphs 500-515, the x-axis represents crank angle (indicative of when the signal or data was collected in the combustion cycle) and the y-axis represents amplitude. In graph 515, the peak amplitude of the residual constituent is 0.24. In one example, the third predetermined threshold may be 0.2, the second predetermined threshold may be 0.15, and the first predetermined threshold may be 0.1. In this example, based on the residual constituent illustrated in the graph 515, a high intensity knocking combustion occurred because 0.24 is greater than the third predetermined threshold of 0.2. In some implementations, it is determined that a high intensity knocking combustion occurred when the peak amplitude of the residual constituent is greater than or equal to the third predetermined threshold.

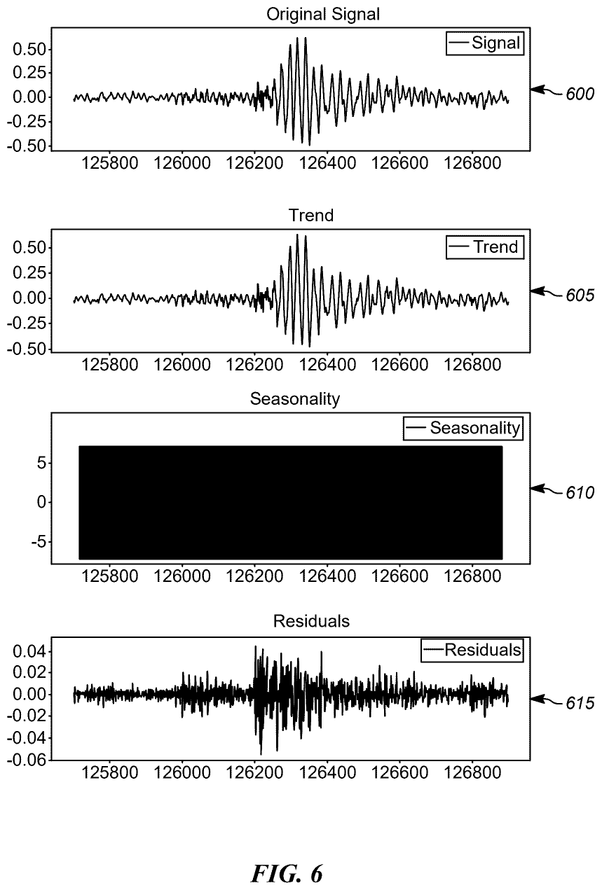

FIG. 6 includes an example of a noisy signal received when a knocking combustion did not occur in a cylinder and the constituents of the noisy signal. Graph 600 represents the original signal received from a single knock sensor (for example, the knock sensor 230). Graph 605 represents the trend constituent of the signal illustrated in the graph 600. Graph 610 represents the seasonality constituent of the signal illustrated in the graph 600. Graph 615 represents the residual constituent of the signal illustrated in the graph 600. In each of the graphs 600-615, the x-axis represents crank angle (indicative of when the signal or data was collected in the combustion cycle) and the y-axis represents amplitude. In graph 615, the peak amplitude of the residual constituent is 0.04. In one example, the third predetermined threshold may be 0.2, the second predetermined threshold may be 0.15, and the first predetermined threshold may be 0.1. In this example, based on the residual constituent illustrated in the graph 615, a knock did not occur because 0.04 is less than the first predetermined threshold of 0.1. In some implementations, it is determined that a knocking combustion occurred when the peak amplitude of the residual constituent is greater than or equal to the first predetermined threshold. When noisy signals such as the one illustrated in FIG. 6 are received, currently implemented systems and methods for detecting knock (systems and methods that do not utilize ARIMA) often incorrectly determine that a combustion is a knocking combustion because the amplitude of the received signal is high. The implementations described herein, utilizing ARIMA, are less likely to incorrectly determine that a knocking combustion occurred when a noisy signal is received.

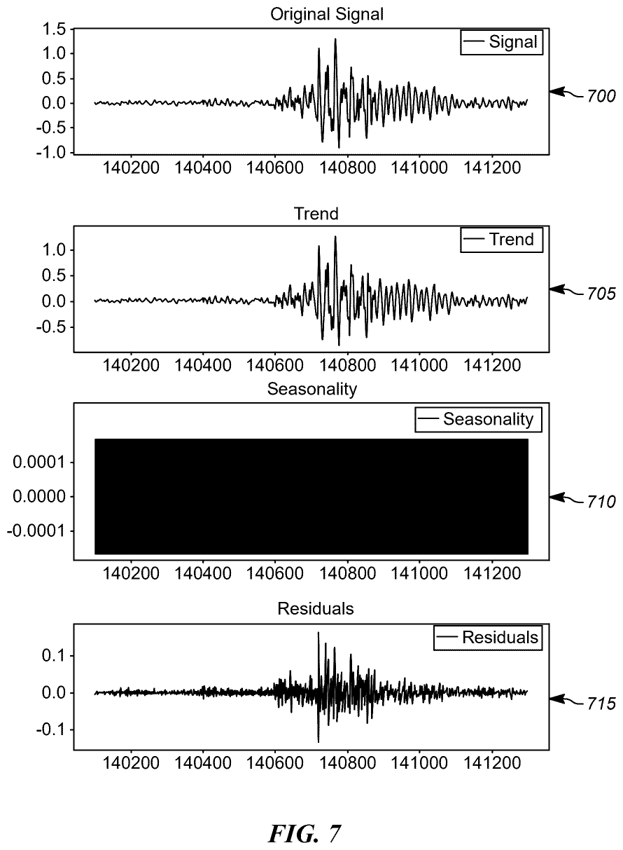

FIG. 7 includes an example of a signal received when a light intensity knocking combustion occurred in a cylinder and the constituents of the signal. Graph 700 represents the original signal received from a single knock sensor (for example, the knock sensor 230). Graph 705 represents the trend constituent of the signal illustrated in the graph 700. Graph 710 represents the seasonality constituent of the signal illustrated in the graph 700. Graph 715 represents the residual constituent of the signal illustrated in the graph 700. In each of the graphs 700-715, the x-axis represents crank angle (indicative of when the signal or data was collected in the combustion cycle) and the y-axis represents amplitude. In graph 715, the peak amplitude of the residual constituent is 0.14. In one example, the third predetermined threshold may be 0.2, the second predetermined threshold may be 0.15, and the first predetermined threshold may be 0.10. In this example, based on the residual constituent illustrated in the graph 715, a light intensity knocking combustion occurred because 0.14 is less than the second predetermined threshold of 0.15 and greater than the first predetermined threshold of 0.1. In some implementations, it is determined that light intensity knocking combustion occurred when the peak amplitude of the residual constituent is greater than or equal to the first predetermined threshold and is less than the second predetermined threshold. FIG. 7 also illustrates that even when the amplitude of the original signal is high, the amplitude of the residual constituent, and thus the knocking intensity, is not necessarily high as well. Therefore, it is not always possible to identify whether a combustion is a knocking or non-knocking combustion or correctly determine the intensity of a knocking combustion based on the original signal in isolation because the original signal may have noise components that do not correspond to knock.

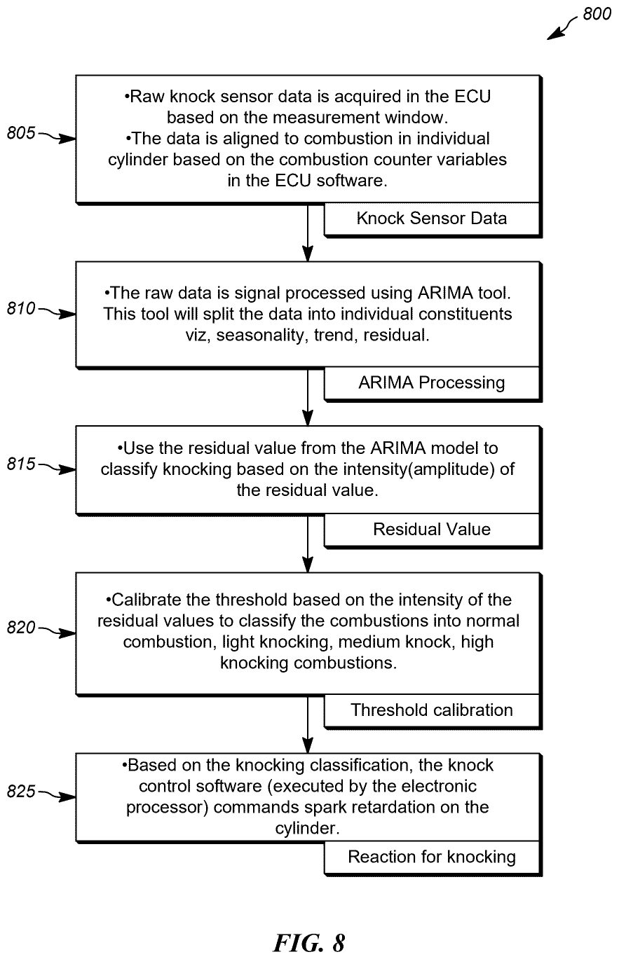

FIG. 8 provides another example flowchart of a method 800 for detecting knock using an ARIMA model. Similar to block 405 of the method 400, at block 805, the electronic processor 300 receives a signal from a knock sensor (for example, the knock sensor 230). At block 805, when the engine is a multi-cylinder engine 210, the electronic processor 300 also determines the cylinder associated with the received signal. In some implementations, when the engine 210 is a multi-cylinder engine and there are multiple knock sensors included in the system 100, each cylinder included in the engine 210 is assigned to a particular knock sensor. In some implementations, a measurement window (or a predetermined window of time) in the combustion cycle is assigned to each cylinder. As the signal produced by a knock sensor is continuous, the measurement window corresponding to a cylinder may be used to locate the combustion of that cylinder on the knock sensor signal. For example, when the engine 210 includes six cylinders and the system includes three knock sensors, two cylinders are assigned to each knock sensor (for example, cylinder 1 and cylinder 2 are both assigned to knock sensor 1, cylinder 3 and cylinder 4 are each assigned to knock sensor 2, and cylinder 5 and cylinder 6 are each assigned to knock sensor 3) and there are total six measurement windows each assigned to a cylinder based on the firing order of the six cylinders (for example, measurement window 1 is assigned to cylinder 1, measurement window 2 is assigned to cylinder 2, measurement window 3is assigned to cylinder 3, etc.). In this example, assuming the firing order is 1-5-3-6-2-4, when cylinder 1 is firing, the signal received from knock sensor 1 during measurement window 1 is analyzed by the electronic processor 300 to determine whether the combustion that occurred in cylinder 1 is a knocking combustion or a non-knocking combustion and when cylinder 5 fires, the signal from knock sensor 3 during measurement window 5 is analyzed by the electronic processor 300 to determine whether the combustion that occurs in cylinder 5 is a knocking combustion or a non-knocking combustion.

At block 810, similar to block 410, the electronic processor 300 determines the constituents of the received signal. At block 815, the electronic processor 300 determines the amplitude of the residual constituent. At block 820, the electronic processor 300 compares the amplitude to one or more thresholds to determine whether a combustion is a knocking combustion or a non-knocking combustion.

As illustrated by block 825 of the method 800, when the electronic processor 300 determines that knock occurred, the electronic processor 300 may control the spark plug to adjust the timing of a spark in a future combustion cycle. In some implementations, the electronic processor 300 adjusts the timing of a spark in the combustion cycle based on the strength of the knock (for example, whether a light intensity, medium intensity, or high intensity knocking combustion occurred). For example, when a high intensity knocking combustion occurs, the electronic processor 300 may more dramatically adjust (relative to how the electronic processor 300 adjusts the timing of the spark when low intensity knocking combustion or medium intensity knocking combustion is detected) the timing of the spark in the combustion cycle. In some implementations, the electronic processor 300 may execute the knock control software 320 to retard the spark of a spark plug (for example, the spark plug 225). In implementations where the engine 210 includes multiple cylinders, the electronic processor 300 may control the spark plug associated with the cylinder determined to be associated with the signal received from a knock sensor included in the system 200.

Thus, examples, aspects, and features herein provide, among other things, systems and methods for detecting knock using an ARIMA model.

What is claimed is:

1. A system for detecting knock using an Autoregressive Integrated Moving Average (ARIMA) model, the system comprising:
an electronic processor, the electronic processor configured to:
receive a signal from a knock sensor;
using the ARIMA model, determine constituents of the signal, wherein the constituents include a residual constituent; and
determine, based on an amplitude of the residual constituent, whether a combustion is a knocking combustion or a non-knocking combustion.

2. The system according to claim 1, wherein the electronic processor is configured to:
when knock occurred, adjust timing of a spark in a future combustion cycle.

3. The system according to claim 1, wherein the electronic processor is configured to determine, based on the amplitude of the residual constituent, whether a combustion is a knocking combustion or a non-knocking combustion by:
when the combustion is a knocking combustion,
determining strength of the knocking combustion based on the amplitude of the residual constituent and the electronic processor is further configured to:
adjusting timing of a spark in a combustion cycle based on the strength of the knocking combustion.

4. The system according to claim 1, wherein the received signal represents data collected during a predetermined window of time.

5. The system according to claim 1, wherein the electronic processor is configured to determine, based on an amplitude of the residual constituent, whether a combustion is a knocking combustion or a non-knocking combustion by:
classifying the combustion as a light intensity knocking combustion, a medium intensity knocking combustion, a high intensity knocking combustion, or a non-knocking combustion.

6. The system according to claim 1, wherein the system includes an engine with a plurality of cylinders and the electronic processor is further configured to:
determine a cylinder associated with the signal received from the knock sensor; and
when the combustion is a knocking combustion, adjust timing of a spark in a future combustion cycle based on the determined cylinder.

7. The system according to claim 1, wherein the constituents include a seasonality constituent, a trend constituent, and the residual constituent.

8. A method for detecting knock using an Autoregressive Integrated Moving Average (ARIMA) model, the method comprising:
receiving a signal from a knock sensor;
using the ARIMA model, determining constituents of the signal, wherein the constituents include a residual constituent; and
determining, based on an amplitude of the residual constituent, whether a combustion is a knocking combustion or a non-knocking combustion.

9. The method according to claim 8, the method further comprising:
when knock occurred, adjusting timing of a spark in a future combustion cycle.

10. The method according to claim 8, wherein determining, based on the amplitude of the residual constituent, whether a combustion is a knocking combustion or a non-knocking combustion includes:
when the combustion is a knocking combustion,
determining strength of the knocking combustion based on the amplitude of the residual constituent; and
adjusting timing of a spark in a combustion cycle based on the strength of the knocking combustion.

11. The method according to claim 8, wherein the received signal represents data collected during a predetermined window of time.

12. The method according to claim 8, wherein determining, based on the amplitude of the residual constituent, whether a combustion is a knocking combustion or a non-knocking combustion includes:
classifying the combustion as a light intensity knocking combustion, a medium intensity knocking combustion, a high intensity knocking combustion, or a non-knocking combustion.

13. The method according to claim 8, the method further comprising:
determining a cylinder associated with the signal received from the knock sensor; and
when the combustion is a knocking combustion, adjusting timing of a spark in a future combustion cycle based on the determined cylinder.

14. The method according to claim 8, wherein the constituents include a seasonality constituent, a trend constituent, and the residual constituent.
